(19) United States
(12) Patent Application Publication
(10) Pub. No.: US 2026/0074210 A1
(43) Pub. Date: Mar. 12, 2026

(54) COMPOSITE ACTIVE MATERIAL AND BATTERY

(71) Applicant: Toyota Jidosha Kabushiki Kaisha, Toyota-shi (JP)

(72) Inventors: Jun YOSHIDA, Mishima-shi (JP); Masaru Kubota, Okazaki-shi (JP); Masahiro Morimoto, Susono-shi (JP)

(73) Assignee: Toyota Jidosha Kabushiki Kaisha, Toyota-shi (JP)

(21) Appl. No.: 19/245,773

(22) Filed: Jun. 23, 2025

(30) Foreign Application Priority Data
Sep. 6, 2024 (JP) 2024-154132

(51) Int. Cl. H01M 4/505; H01M 4/02; H01M 4/36

(52) U.S. Cl. CPC H01M 4/505; H01M 4/366; H01M 2004/021; H01M 2004/028

(57) ABSTRACT

A composite active material in the present disclosure includes an active material particle and a coat layer. The active material particle has an O2-type structure. The active material particle contains Li, at least one transition metal element of Mn, Ni, and Co, and O, as constituent elements. The coat layer covers at least a part of a surface of the active material particle. The coat layer is a layer of an oxide that contains Li as a constituent element. A particle diameter (D50) of the composite active material is less than 5.90 μm.

### CROSS-REFERENCE TO RELATED APPLICATION

This application claims priority to Japanese Patent Application No. 2024-154132 filed on Sep. 6, 2024. The disclosure of the above-identified application, including the specification, drawings, and claims, is incorporated by reference herein in its entirety.

### BACKGROUND

### 1. Technical Field

The present application discloses a composite active material and a battery.

### 2. Description of Related Art

Japanese Unexamined Patent Application Publication No. 2022-085829 (JP 2022-085829 A) discloses an electrode active material having an O2-type structure (O: Octahedral). The electrode active material having the O2-type structure is obtained by the ion exchange of at least a portion of Na of a Na-containing oxide having a P2-type structure for Li.

### SUMMARY

The electrode active material having the O2-type structure has room for improvement in terms of capacity and resistance.

The present application discloses a plurality of aspects described below, as means for solving the above problem.

### Aspect 1

Aspect 1 of the disclosure relates to a composite active material including an active material particle and a coat layer. The active material particle has an O2-type structure. The active material particle contains, as constituent elements, Li, at least one transition metal element of Mn, Ni, and Co, and O. The coat layer covers at least a part of a surface of the active material particle. The coat layer is a layer of an oxide that contains Li as a constituent element. A particle diameter (D50) of the composite active material is less than 5.90 μm.

### Aspect 2

In the composite active material according to aspect 1, the coat layer may contain Li, B, P, and O, as constituent elements.

### Aspect 3

In the composite active material according to aspect 1 or 2, the particle diameter (D50) of the composite active material may be 5.42 μm or less.

### Aspect 4

In the composite active material according to any one of aspect 1 to 3, the active material particle may contain Li, Mn, Ni, Co, and O, as constituent elements.

### Aspect 5

Aspect 5 of the disclosure relates to a battery including a positive electrode active material layer, an electrolyte layer, and a negative electrode active material layer. The positive electrode active material layer contains the composite active material according to any one of aspects 1 to 4.

The composite active material in the present disclosure has a high capacity and a low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of the configuration of the interior (cross-section) of a composite active material;

FIG. 2 is a schematic diagram for describing a method of identifying an aspect ratio about a cross-section shape of an active material particle;

FIG. 3 shows an example of the external appearance of the composite active material;

FIG. 4 shows an example of the flow of a production method for the composite active material;

FIG. 5 schematically shows an example of the configuration of a battery;

FIG. 6 is a SEM image about a composite active material according to Example 1;

FIG. 7 is a SEM image about a composite active material according to Example 2;

FIG. 8 is a SEM image about a composite active material according to Comparative Example 1; and

FIG. 9 is a SEM image about a composite active material according to Comparative Example 2.

### DETAILED DESCRIPTION OF EMBODIMENTS

Embodiments of a composite active material and a battery in the present disclosure will be described below. The composite active material and the battery in the present disclosure are not limited to the embodiments described below.

### 1. Composite Active Material

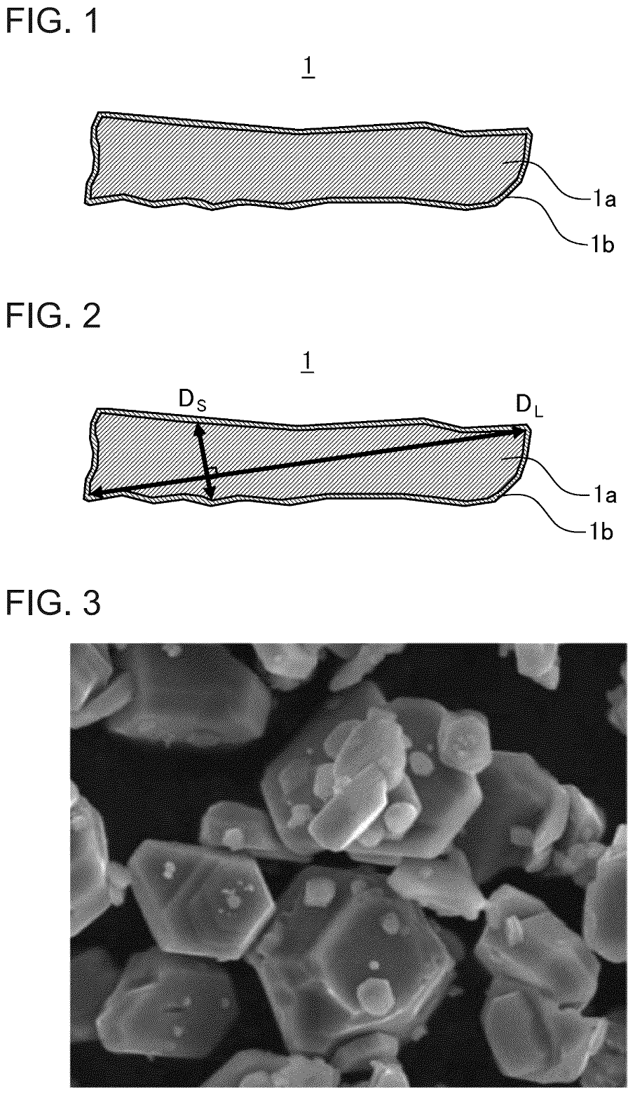

As shown in FIG. 1, a composite active material 1 according to an embodiment includes an active material particle 1a and a coat layer 1b. The active material particle 1a has an O2-type structure. The active material particle 1a contains Li, at least one transition metal element of Mn, Ni, and Co, and O, as constituent elements. The coat layer 1b covers at least a part of a surface of the active material particle 1a. The coat layer 1b is a layer of an oxide that contains Li as a constituent element. A particle diameter (D50) of the composite active material 1 is less than 5.90 μm.

### 1.1 Active Material Particle

The active material particle 1a has the O2-type structure. Further, the active material particle 1a contains Li, at least one transition metal element of Mn, Ni, and Co, and O, as constituent elements.

### 1.1.1 Crystal Structure of Active Material Particle

The active material particle 1a has the O2-type structure (which belongs to a space group P63mc). The active material particle 1a according to the embodiment may have a crystal structure other than the O2-type structure, while having the O2-type structure. Examples of the crystal structure other than the O2-type structure include a T #2-type structure (which belongs to a space group Cmca) that is formed by the deinsertion of Li from the O2-type structure, and an O6-type structure (which belongs to a space group R-3m, has a c-axis length of 2.5 nm or more and 3.5 nm or less, typically, a c-axis length of 2.9 nm or more and 3.0 nm or less, and is different from an O3-type structure belonging to the space group R-3m similarly). The active material particle 1a according to the embodiment may have the O2-type structure as a main phase, or may have a crystal structure other than the O2-type structure as the main phase. In the active material particle 1a according to the embodiment, the crystal structure that is the main phase can be changed depending on the charge-discharge state. The active material particle 1a according to the embodiment may be a monocrystal constituted by one crystallite, or may be a polycrystal including a plurality of crystallites.

### 1.1.2 Chemical Composition of Active Material Particle

The active material particle 1a contains Li, at least one transition metal of Mn, Ni, and Co, and O, as constituent elements. Particularly, in the case where the active material particle 1a contains Li, Mn, one or both of Ni and Co, and O as constituent elements, more particularly, in the case where the active material particle 1a contains Li, Mn, Ni, Co, and O as constituent elements, a higher performance is easily obtained. The active material particle 1a may contain an element other than Li, Mn, Ni, Co, and O.

The active material particle 1a may have a chemical composition shown as LiₐNa_{b}Mnₓ₋ₚNi_{y-q}Co_{z-r}M_{p+q+r}O₂ (0<a≤1.40, 0≤b≤0.20, x+y+z=1, and 0≤p+q+r<0.17 are satisfied, and the element M is at least one kind selected from B, Mg, Al, K, Ca, Ti, V, Cr, Fe, Cu, Zn, Ga, Ge, Sr, Y, Zr, Nb, Mo, and W). In the case where an active material portion lax has this chemical composition, a high performance is easily secured, and the O2-type structure is easily maintained. In the above chemical composition, a is more than 0, and may be 0.10 or more, 0.20 or more, 0.30 or more, 0.40 or more, 0.50 or more, or 0.60 or more. Further, a is 1.40 or less, and may be 1.30 or less, 1.20 or less, 1.10 or less, 1.00 or less, 0.90 or less, 0.80 or less, or 0.70 or less. In the above chemical composition, b is 0 or more, and may be 0.01 or more, 0.02 or more, or 0.03 or more. Further, b is 0.20 or less, and may be 0.15 or less, or 0.10 or less. Further, x is 0 or more, and may be 0.10 or more, 0.20 or more, 0.30 or more, or 0.40 or more. Further, x is 1.00 or less, and may be 0.90 or less, 0.80 or less, 0.70 or less, 0.60 or less, 0.50 or less, or 0.40 or less. Further, y is 0 or more, and may be 0.10 or more, or 0.20 or more. Further, y is 1.00 or less, and may be 0.90 or less, 0.80 or less, 0.70 or less, 0.60 or less, 0.50 or less, 0.40 or less, 0.30 or less, or 0.20 or less. Further, z is 0 or more, and may be 0.10 or more, 0.20 or more, 0.30 or more, or 0.40 or more. Further, z is 1.00 or less, and may be 0.90 or less, 0.80 or less, 0.70 or less, 0.60 or less, 0.50 or less, or 0.40 or less. The contribution of the element M to charge and discharge is small. In this regard, since p+q+r is less than 0.17 in the above chemical composition, a high charge-discharge capacity is easily secured. Further, p+q+r may be 0.16 or less, 0.15 or less, 0.14 or less, 0.13 or less, 0.12 or less, 0.11 or less, or 0.10 or less. Meanwhile, since the element M is contained, the O2-type structure is easily stabilized. In the above chemical composition, p+q+r is 0 or more, and may be 0.01 or more, 0.02 or more, 0.03 or more, 0.04 or more, 0.05 or more, 0.06 or more, 0.07 or more, 0.08 or more, 0.09 or more, or 0.10 or more. The composition of O is about 2, but is not constant.

### 1.1.3 Shape of Active Material Particle

The shape of the active material particle 1a is not particularly limited. For example, the active material particle 1a may have a plate shape. As described later, the active material particle 1a can be obtained by substituting Na of an Na-containing oxide having a P2-type structure with Li. The P2-type structure is a hexagonal system, the diffusion coefficient of Na ions is large, and the crystal easily grows in a specific direction. Particularly, in the case where at least one of Mn, Ni, and Co is contained as a transition metal element composing the P2-type structure, the crystal easily grows in a specific direction so as to have a plate shape. Therefore, the Na-containing oxide having the P2-type structure easily becomes a plate-shaped particle in which the growth direction of the crystal is biased to a specific direction and that has a large aspect ratio. The active material particle 1a according to the embodiment may be obtained from such a plate-shaped Na-containing oxide particle.

In the present application, when the active material particle 1a has the “plate shape”, a predetermined cross-section shape of the active material particle 1a has an aspect ratio of 1.5 or more. The “aspect ratio” about the cross-section shape of the active material particle 1a is measured as follows.

(1) A sample for cross-section observation is obtained by the press forming of a plurality of composite active materials 1 with resin and metal powder (alternatively, an electrode containing composite active materials 1 may be used as the sample for cross-section observation). Cross-section processing is performed to the sample, using a cross-section making device (an ion milling device: IM4000II manufactured by Hitach High-Tech Corporation). The cross-section is along a pressure giving direction at the time of the press forming.

(2) The sample after the cross-section processing is mounted on an FE-SEM, and the cross-section is checked.

(3) An element mapping analysis (oxygen, sulfur) of the cross-section of the composite active material 1 is performed using an EDX manufactured by Oxford Instruments, and an element mapping for each element is obtained using EDX analysis software (AZtecLive) manufactured by Oxford Instruments.

(4) The cross-section shape of the active material particle 1a is identified from the obtained mapping region for OKα1, and the like.

(5) The maximal Feret's diameter is identified in the identified cross-section shape, and is regarded as a “long diameter” of the active material particle 1a. For example, a long diameter DL in the cross-section shape of the active material particle 1a is identified as shown in FIG. 2.

(6) Among line segments that connect two points on the outer circumference of the identified cross-section shape and that are orthogonal to the “long diameter” identified in (5), the longest line segment is regarded as a “short diameter” of the active material particle 1a. For example, a short diameter D_{S} in the cross-section shape of the active material particle 1a is identified as shown in FIG. 2.

(7) The ratio (long diameter/short diameter) of the identified “long diameter” and the identified “short diameter” is regarded as the “aspect ratio” in the predetermined cross-section shape of the active material particle 1a, and in the case where the “aspect ratio” is 1.5 or more, the shape of the active material particle 1a is regarded as the “plate shape”. The upper limit of the aspect ratio is not particularly limited. For example, the aspect ratio may be 10 or less.

For example, the particle diameter (D50) of the active material particle 1a may be 0.10 μm or more, 1.00 μm or more, 1.50 μm or more, or 2.00 μm or more, and may be 5.00 μm or less, 4.00 μm or less, or 3.50 μm or less. In the present application, the “particle diameter (D50)” about the active material particle 1a and the composite active material 1 is a particle diameter (median size) at an integrated value of 50% in a volume-basis particle size distribution obtained by a laser diffracting-scattering method. For the active material particle 1a, the particle size distribution can be measured by a met method. For the composite active material 1, the particle size distribution preferably should be measured by a dry method, for inhibiting the elution of the coat layer 1b.

For example, a particle diameter (D90) of the active material particle 1a may be 2.00 μm or more, 3.00 μm or more, or 4.00 μm or more, and may be 8.00 μm or less, 7.00 μm or less, or 6.00 μm or less. In the present application, the “particle diameter (D90)” about the active material particle 1a and the composition active material 1 is a particle diameter at an integrated value of 90% in the volume-basis particle size distribution obtained by the laser diffracting-scattering method.

For example, a particle diameter (D10) of the active material particle 1a may be 0.10 μm or more, 0.50 μm or more, or 1.00 μm or more, and may be 4.00 μm or less, 3.00 μm or less, or 2.00 μm or less. In the present application, the “particle diameter (D10)” about the active material particle 1a and the composition active material 1 is a particle diameter at an integrated value of 10% in the volume-basis particle size distribution obtained by the laser diffracting-scattering method.

### 1.2 Coat Layer

As shown in FIG. 1, at least a part of the surface of the active material particle 1a is covered with the coat layer 1b. The coat layer 1b is the later of the oxide that contains Li as a constituent element. In the embodiment, the coat layer 1b may contain Li, B, P, and O, as constituent elements. In the case where the coat layer 1b contains Li, B, P, and O as constituent elements, the resistance and others of the composite active material 1 are further easily improved. Alternatively, the coat layer 1b may has a chemical composition other than the above chemical composition.

### 1.2.1 Kind of Coat Layer

The coat layer 1b is the layer of the oxide that contains Li, and in other words, the coat layer 1b is the layer of an oxide (oxide solid electrolyte) that has Li-ion conductibility. That is, the coat layer 1b only needs to be a coat layer that inhibits the active material particle 1a from making contact directly with another material and that allows the securement of a Li-ion conduction path. The Li-ion conductive substance may be an inorganic compound or an organic compound. Particularly, in the case of the inorganic compound, a high performance is easily secured. Further, the coat layer 1b may be a coat layer that does not substantially contain the organic compound (the content of the organic compound is less than 0.01 mass %).

In the case where the coat layer 1b is composed of the inorganic compound having the Li-ion conductibility, the inorganic compound contains a Li-containing oxide, and may optionally further contain another inorganic compound (for example, a Li-containing halide). Particularly, in the case where the coat layer 1b contains Li, B, P, and O as constituent elements, as described above, a high performance is easily secured. In the case where the coat layer 1b contains Li, B, P, and O as constituent elements, the proportion of Li contained in the coat layer 1b may be 20 mol % or more and 50 mol % or less, for example. Further, the proportion of P contained in the coat layer 1b may be 5 mol % or more and 20 mol % or less, for example. Further, the mole ratio (B/P) of B to P contained in the coat layer 1b may be 0.5 or more and 2.0 or less, for example. Further, the mole ratio (Li/(P+B)) of Li to the total of P and B contained in the coat layer 1b may be 0.3 or more and 1.2 or less, for example. The proportions of the elements can be identified by the element analysis with SEM-EDX and ICP analysis. Further, the proportion of O contained in the coat layer 1b can be evaluated as an oxygen concentration by a heat melting method, for example. As for the coat layer 1b, the oxygen concentration that is evaluated by the heat melting method may be 45 weight % or more and 60 weight % or less, for example. The proportion of O contained in the coat layer 1b may be 30 mol % or more and 60 mol % or less, for example.

The Li-containing oxide composing the coat layer 1b may an oxide that contains Li and an element A other than Li. For example, the Li-containing oxide may contain at least one kind of element A selected from B, C, Al, Si, P, S, Ti, La, Zr, Nb, Mo, Zn, and W, Li, and O. Particularly, in the case where the element A contains B and P, a higher performance is easily secured. The Li-containing oxide may be an oxynitride that contains N. More specifically, the Li-containing oxide may be at least one kind selected from Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MOO₄, Li₂WO₄, LiPON, Li—B—P—O, Li₂O—LaO₂, Li₂O—ZnO₂, and the like. In the Li-containing oxide, some elements may be substituted with various dope elements.

The coat layer 1b may contain a Li-containing halide. For example, the Li-containing halide may contain at least one kind of element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm, at least one kind of halogen element selected from the group consisting of Cl, Br, I, and F, and Li. The Li-containing halide may contain at least one kind selected from the group consisting of Ti, Al, Gd, Ca, Zr, and Y, at least one kind selected from the group consisting of Cl, Br, I, and F, and Li. Further, the Li-containing halide may contain at least one kind of element selected from the group consisting of Ti and Al, at least one kind of element selected from the group consisting of Cl, Br, I, and F, and Li. Further, for example, the Li-containing halide may be a composite halide of Li, Ti, Al, and F.

### 1.2.2 Coverage of Coat Layer

The coat layer 1b can cover a part or whole of the surface of the active material particle 1a. For example, the coat layer 1b may cover 70 area % or more, 80 area % or more, 90 area % or more, 95 area % or more, or 99 area % or more of the surface of the active material particle 1a. The coverage of the coat layer 1b for the active material particle 1a can be identified, for example, by the element analysis about the external appearance or cross-section of the composite active material 1.

### 1.2.3 Thickness of Coat Layer

For example, the thickness of the coat layer 1b may be 0.1 nm or more and 100 nm or less, or 1 nm or more and 50 nm or less. The thickness of the coat layer 1b can be identified by observing the cross-section of the composite active material 1 with a scanning electron microscope (SEM) or a transmission electron microscope (TEM).

### 1.2.4 Others

The coat layer 1b may directly cover the active material particle 1a, or may indirectly cover the active material particle 1a. The “indirectly cover” means that a different layer from the coat layer 1b exists between the active material particle 1a and the coat layer 1b.

### 1.3 Shape of Composite Active Material

The composite active material 1 includes the above-described active material particle 1a and the coat layer 1b. As shown in FIG. 3, the composite active material 1 has a particle shape. In the composite active material 1, a secondary particle may be constituted by the aggregation of a plurality of active material particles 1a through coat layers 1b. However, in the embodiment, it is important that the composite active material 1 has a small particle diameter as a whole.

As described above, the active material particle having the O2-type structure is produced by the ion exchange of the Na-containing oxide having the P2-type structure. In the P2-type structure, the crystal easily grows in a specific direction, and an end portion in the crystal growth direction can become a gateway for intercalation. Therefore, in the active material particle having the O2-type structure obtained after the ion exchange, the Li diffusion distance in a bulk is prone to be long. According to inventor's knowledge, in the case where the composite active material is obtained such that the active material particle is covered with the coat layer, when the particle diameter (D50) of the composite active material is excessively large, the Li diffusion distance in the composite active material is long, so that Li conductibility or the like is prone to be low. In response, in the composite active material 1 according to the embodiment, the particle diameter (D50) is small, and is less than 5.90 μm, and the Li diffusion distance as the whole of the composite active material 1 is short. As a result, as the whole of the composite active material 1, a high capacity and a low resistance are easily obtained. Particularly, in the case where the active material particle 1a is a particle having a plate shape, the effect of the technology in the present disclosure is further remarkably exerted. The particle diameter (D50) of the composite active material 1 may be 5.85 μm or less, 5.80 μm or less, 5.75 μm or less, 5.70 μm or less, 5.65 μm or less, 5.60 μm or less, 5.55 μm or less, 5.50 μm or less, 5.45 μm or less, or 5.42 μm or less. The lower limit of the particle diameter (D50) of the composite active material 1 is not particularly limited. The particle diameter (D50) of the composite active material 1 may be 2.00 μm or more, 3.00 μm or more, 4.00 μm or more, or 5.00 μm or more.

For example, the particle diameter (D90) of the composite active material 1 may be more than 2.00 μm, 3.00 μm or more, 4.00 μm or more, or 5.00 μm or more, and may be 10.00 μm or less, 9.50 μm or less, or 9.00 μm or less.

For example, the particle diameter (D10) of the composite active material 1 may be more than 1.00 μm, 2.00 μm or more, or 3.00 μm or more, and may be 5.00 μm or less, 4.50 μm or less, 4.00 μm or less, or 3.50 μm or less.

### 2. Production Method for Composite Active Material

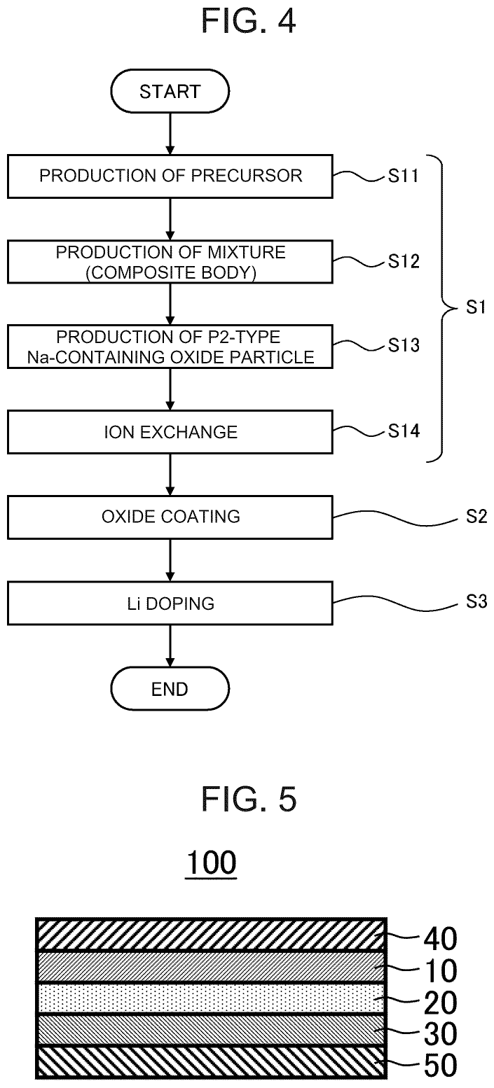

For example, the above-descried composite active material 1 can be produced by the following method. As shown in FIG. 4, a production method for the composite active material 1 according to an embodiment includes
S1: obtaining the active material particle 1a, and
S2: covering at least a part of the surface of the active material particle 1a with the coat layer 1b by spray dry (oxide coating).

The active material particle 1a has the O2-type structure. The active material particle 1a contains Li, at least one transition metal element of Mn, Ni, and Co, and O, as constituent elements. The coat layer 1b is the layer of the oxide that contains Li as a constituent element. In the embodiment, a spray dry condition (particularly, an atomizing air pressure) in S2 may be controlled such that the particle diameter (D50) of the composite active material 1 that is finally obtained is less than 5.90 μm.

### 2.1 S1

In S1, the active material particle 1a that has the O2-type structure and that contains the predetermined constituent elements can be obtained by the following method, for example. As shown in FIG. 4, S1 may include
S11: obtaining a precursor that contains at least one transition metal element of Mn, Ni, and Co,
S12: obtaining a mixture by mixing the precursor and a Na source,
S13: obtaining a Na-containing oxide particle having the P2-type structure, by firing the mixture, and
S14: obtaining a Li-containing oxide particle having the O2-type structure, by the ion exchange of at least a portion of Na of the Na-containing oxide particle for Li.

### 2.1.1 Production of Precursor

The precursor contains at least one transition metal element of Mn, Ni, and Co. The precursor may contain Mn and one or both of the Ni and Co, or may contain at least Mn, Ni, and Co. The precursor may be a salt that contains at least one element of Mn, Ni, and Co. For example, the precursor may be at least one kind of a carbonate, a sulfate, a nitrate, and an acetate. Alternatively, the precursor may be a compound other than salts. For example, the precursor may be a hydroxide. The precursor may be a hydrate. The precursor may be a combination of a plurality of kinds of compounds. The precursor may have various shapes. For example, the precursor may have a particle shape, and may be a spherical particle as described later. The particle diameter of the precursor particle is not particularly limited.

In S11, a precipitate as the above precursor may be obtained by a coprecipitation method, using an ion source that can form a precipitate in an aqueous solution with a transition metal ion, and a transition metal compound that contains at least one element of Mn, Ni, and Co. Thereby, the spherical particle as the precursor is easily obtained. For example, the “ion source that can form a precipitate in an aqueous solution with a transition metal ion” may be at least one kind selected from a sodium salt such as sodium carbonate and sodium nitrate, a sodium hydroxide, and a sodium oxide. The transition metal compound may be the above salt, hydroxide or the like that contains at least one element of Mn, Ni, and Co. Specifically, in S1, the precipitate as the precursor may be obtained by making solutions containing the ion source and the transition metal compound respectively and then dropping and mixing the respective solutions. On this occasion, for example, water is used as a solvent. On this occasion, various sodium compounds may be used as a base, and an ammonia aqueous solution or the like may be added for the adjustment of the base property. In the case of the coprecipitation method, the precipitate as the precursor is obtained, for example, by preparing the aqueous solution of the transition metal compound and the aqueous solution of sodium carbonate and dropping and mixing the respective aqueous solutions. Alternatively, the precursor can be obtained by a sol-gen method.

In S11, the precursor may contain the element M. The element M is at least one kind selected from B, Mg, Al, K, Ca, Ti, V, Cr, Cu, Zn, Ga, Ge, Sr, Y, Zr, Nb, Mo, and W. For example, the element M has a function to stabilize the P2-type structure and the O2-type structure. The method for obtaining the precursor that contains the element M is not particularly limited. In the case where the precursor is obtained by the coprecipitation method in S1, the precursor that contains the element M together with at least one element of Mn, Ni, and Co is obtained, for example, by preparing the aqueous solution of a transition metal compound containing at least one of Mn, Ni, and Co, the aqueous solution of sodium carbonate, and the aqueous solution of the compound of the element M, and dropping and mixing the respective aqueous solutions. Alternatively, in the production method in the present disclosure, the doping of the element M may be performed in S12 and S13 described later, without adding the element M in S11.

### 2.1.2 Production of Mixture (Composite Body)

In S12, the mixture is obtained by mixing the precursor obtained in S11 and the Na source. In S12, a composite body may be obtained by covering the surface of the precursor with the Na source. The Na source may be a salt that contains Na, as exemplified by a carbonate and a nitrate, or may be a compound other than salts, as exemplified by sodium oxide and sodium hydroxide. In S12, the amount of the Na source with respect to the precursor may be decided in consideration of a Na loss quantity at the time of firing after that. In the case where the surface of the precursor is covered with the Na source in S12, the coverage of the Na source for the surface of the precursor is not particularly limited. The method for covering the surface of the precursor with the Na source in S12 is not particularly limited. For example, the precursor and the Na source may be mixed by a mortar or a mixing device, or using a roll flow coating method, a spray dry method, or the like, a solution containing the Na source may be caused to make contact with the precursor, and then drying may be performed.

In S12, an M source may be mixed with the precursor, as well as the Na source. For example, in S12, the mixture may be obtained by mixing the precursor obtained in S1, the Na source, and the M source that contains at least one kind of element M selected from B, Mg, Al, K, Ca, Ti, V, Cr, Cu, Zn, Ga, Ge, Sr, Y, Zr, Nb, Mo, and W. For example, the M source may be a salt that contains the element M, as exemplified by a carbonate and a sulfate, or may be a compound other than salts, as exemplified by an oxide and a hydroxide. The amount of the M source with respect to the precursor may be decided depending on the chemical composition of the Na-containing oxide after firing.

### 2.1.3 Production of P2-Type Na-Containing Oxide Particle

In S13, the Na-containing oxide having the P2-type structure is obtained by firing the mixture (composite body) obtained in S12. S13 may include
S13-1: performing preliminary firing to the mixture at a temperature of 300° C. or higher and lower than 700° C. for a time of 1 hour or more and 10 hours or less,
S13-2: performing real firing to the mixture at a temperature of 700° C. or higher and 1100° C. or lower for a time of 30 minutes or more and 48 hours or less, subsequent to the preliminary firing,
S13-3: rapidly cooling the composite body from a temperature T₁ of 200° C. or higher to a temperature T₂ of 100° C. or lower, subsequent to the real firing.

In S13-1, the preliminary firing is performed to the mixture (composite body) at a temperature of 300° C. or higher and lower than 700° C. for a time of 2 hours or more and 10 hours or less. In S13-1, the preliminary firing may be performed after the above mixture is freely shaped. The preliminary firing is performed at a temperature lower than the temperature in the real firing. When the preliminary firing in S13-1 is insufficient, the generation of a P2 phase can become insufficient in the Na-containing oxide that is finally obtained. Since a preliminary firing temperature is 300° C. or higher and lower than 700° C. and a preliminary firing time is 2 hours or more and 10 hours or less in S13-1, the preliminary firing can be sufficiently performed to the mixture. Thereby, the uniformity of heat is enhanced, and an adequate Na-containing oxide is easily obtained by S13-2 and S13-3 described later. The preliminary firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. Further, the preliminary firing time may be 2 hours or more and 8 hours or less, 3 hours or more and 8 hours or less, 4 hours or more and 8 hours or less, 5 hours or more and 8 hours or less, or 5 hours or more and 7 hours or less. A preliminary firing atmosphere is not particularly limited, and may be an oxygen-containing atmosphere, for example.

In S13-2, subsequent to the above preliminary firing, the real firing is performed to the mixture (composite body) at a temperature of 700° C. or higher and 1100° C. or lower for a time of 30 minutes or more and 48 hours or less. In S13-2, a real firing temperature may be 800° C. or higher and 1000° C. or lower. When the real firing temperature is excessively low, the P2 phase is not generated, and when the real firing temperature is excessively high, a different phase from the P2 phase, or the like is easily generated. The condition for the temperature rising from the preliminary firing temperature to the real firing temperature is not particularly limited. In S13-2, the shape of the Na-containing oxide can be controlled by a real firing time. When the real firing time is excessively short, the generation of the P2 phase becomes insufficient. In the embodiment, by setting the real firing time to a certain time or more, the P2 phase easily grows, and the Na-containing oxide particle having a plate shape is easily obtained.

In S13-3, the fired product after the real firing is rapidly cooled from the temperature T₁ of 200° C. or higher to the temperature T₂ of 100° C. or lower (cooling is performed at a temperature decreasing speed of 20° C./min or higher). For example, the preliminary firing and the real firing are performed in a furnace. In step S13-3, for example, after the real firing of the mixture (composite body) is performed in the furnace, cooling is performed to any temperature T₁ of 200° C. or higher in the furnace. After the temperature becomes the temperature T₁, the fired product is taken out from the interior of the furnace, and rapid cooling is performed to any temperature T₂ of 100° C. or lower in the exterior of the furnace. The temperature T₁ is any temperature of 200° C. or higher, and may be any temperature of 250° C. or higher. The temperature T₂ is any temperature of 100° C. or lower, may be any temperature of 50° C. or lower, and may be a cooling end temperature. In a predetermined temperature region between the temperature T₁ and the temperature T₂, fluid easily enters an interlayer of the P2-type structure, due to atom vibration, molecular motion, and the like. It is thought that the amount of the entry of fluid into the interlayer of the P2-type structure becomes small by shortening a time during which the temperature is in a temperature region where fluid easily enters the interlayer of the P2-type structure (that is, performing the rapid cooling), when the fired product (the Na-containing oxide having the P2-type structure) after the real firing is cooled. In this regard, when the fired product after the real firing is cooled in step S13-3, radiational cooling is performed under a dry atmosphere in the exterior of the furnace, from any temperature T₁ of 200° C. or higher to any temperature T₂ of 100° C. or lower, for example. Thereby, the cooling speed from the temperature T₁ to the temperature T₂ becomes a high speed (for example, 20° C./min or higher), and it is hard for fluid to enter the interlayer of the P2-type structure, so that it is possible to inhibit the breakage of the P2-type structure, and the like. As a result, it is possible to efficiently perform the ion exchange of Na for Li, in S14.

### 2.1.4 Ion Exchange

In S14, the Li-containing oxide particle having the O2-type structure is obtained by the ion exchange of at least a portion of Na of the Na-containing oxide particle obtained in S13 for Li. As the ion exchange, for example, there are a method in which an aqueous solution containing lithium halide is used, and a method in which a mixture (for example, a molten salt) of lithium halide and another lithium salt is used. Of the above two methods, the method in which the molten salt is used is preferable from the standpoint of the fragility of the P2-type structure due to the entry of water and the standpoint of crystalline. That is, the Na-containing oxide having the P2-type structure and the molten salt are mixed, and are heated at a temperature higher than or equal to the melting point of the molted salt. Thereby, it is possible to substitute at least a portion of Na of the Na-containing oxide with Li, by ion exchange. It is preferable that the lithium halide composing the molten salt is at least one of lithium chloride, lithium bromide, and lithium iodide. It is preferable that the other lithium salt composing the molten salt is lithium nitrate. When the molten salt is used, the melting point is lower than when the lithium halide or the other lithium salt is used alone, and the ion exchange can be performed at a lower temperature. For example, the temperature in the ion exchange may be higher than or equal to the melting point of the molten salt, and may be 600° C. or lower, 500° C. or lower, 400° C. or lower, or 300° C. or lower. When the temperature in the ion exchange is excessively high, an O3-type structure that is a stabilized phase is easily generated instead of the O2-type structure. Meanwhile, from the standpoint of the shortening of the time for the ion exchange, it is preferable that the temperature in the ion exchange is as high as possible.

### 2.2 S2

In S2, at least a part of the surface of the active material particle 1a obtained in S1 is covered with the coat layer 1b. For example, at least a part of the surface of the Li-containing oxide particle after the above-described ion exchange or the Li-containing oxide particle after later-described Li doping is covered with the coat layer 1b. Thereby, the composite active material 1 shown in FIG. 1 is obtained.

As the method for covering at least a part of the surface of the active material particle 1a with the coat layer 1b in S2, there is a method by spray dry. That is, S2 may include
S2-1: obtaining a solution in which a raw material (for example, a Li source, a B source, or a P source) for forming the coat layer 1b is dissolved,
S2-2: obtaining a slurry by mixing the solution and the active material particle 1a, and
S2-3: covering at least a part of the surface of the active material particle 1a with the coat layer 1b, by spray dry in which the slurry is jetted for drying together with atomizing air.

In S2-1, as the Li source that is dissolved in a solvent, for example, various Li compounds such as lithium hydroxide (LiOH) can be employed. Further, as the B source, for example, various B compounds such as boric acid (H₃BO₃) can be employed. Further, as the P source, for example, various P compounds such as orthophosphoric acid (H₃PO₄) and metaphosphoric acid (HPO₃) can be employed. Further, other element sources may be dissolved in the solvent, depending on an intended composition of the coat layer 1b. Examples of the solvent include water and various organic solvents. The concentration of each element source in the solution may be appropriately adjusted depending on an intended composition of the coat layer 1b.

In S2-2, the solid content concentration in the slurry is not particularly limited, and may be adjusted to a solid content concentration that allows the spray dry.

In S2-3, the particle diameter (D50) of the composite active material 1 that is finally obtained can be controlled by the control of the condition for the spray dry. Specifically, the particle diameter (D50) of the composite active material 1 that is finally obtained can be changed by the atomizing air pressure at the time of the spray dry.

According to inventor's knowledge, as the atomizing air pressure is higher, the aggregation of active material particles 1a is inhibited, and the particle diameter (D50) of the composite active material 1 is likely to become smaller. In S2-3, the atomizing air pressure at the time of the spray dry may be increased such that the particle diameter (D50) of the composite active material 1 becomes less than 5.90 μm. Spray dry conditions other than the atomizing air pressure are not particularly limited.

### 2.3 Li Doping

For example, the production method for the composite active material according to the embodiment may include
S3: further doping the above-described Li-containing oxide particle with Li.

The further doping of the Li-containing oxide particle with Li may be performed before the above-described spray dry, or may be performed after the spray dry. Thereby, the capacity as the active material can be further increased.

In S3, for example, the Li-containing oxide particle after the above-described ion exchange or the composite active material after the above-described spray dry makes contact with a reduction solution that contains the Li ion. The “reduction solution” means a solution that has reducibility, and for example, may be a solution that contains an electrophile. For example, the reduction solution may be obtained by dissolving the electrophile and the Li source in a solvent. As the solvent, various organic solvent in which the electrophile and the Li source can be dissolved can be employed. As the electrophile, various substances that are dissolved in the above solvent can be employed. The electrophile may be an aromatic organic compound. As the Li source, various substances that are dissolved in the above solvent and generate the Li ion can be employed. The Li source may be metal lithium, or may be a Li compound. The concentrations of the electrophile and Li ion that are contained in the reduction solution may be appropriately decided depending on an intended doping amount. As the amount of the Li ion contained in the reduction solution with respect to the amount of the particle that makes contact with the reduction solution is larger, the doping amount of Li in the particle is likely to become larger. The mole ratio (electrophile/Li ion) between the electrophile and Li ion that are contained in the reduction solution is not particularly limited. The way of the contact between the reduction solution and the particle is not particularly limited. For example, the particle may be immersed in the reduction solution, or the reduction solution may be sprayed to the particle. The temperature at the time of the contact is not particularly restricted. Heating may be performed, or may be avoided. Further, stirring may be performed in a state where the particle is immersed in the reduction solution. The time for the contact between the reduction solution and the particle is not particularly restricted, and may be appropriately decided depending on an intended doping amount.

### 3. Battery

A battery according to an embodiment includes the above-described composite active material in the present disclosure. For example, the composite active material in the present disclosure is used as a positive electrode active material of a lithium-ion battery. As shown in FIG. 5, a battery 100 according to an embodiment may include a positive electrode active material layer 10, an electrolyte layer 20, and a negative electrode active material layer 30, and the positive electrode active material layer 10 may contain the composite active material 1 in the present disclosure. The battery 100 can include a positive electrode current collector 40 and a negative electrode current collector 50. The battery 100 may be a solid-state battery, or may be a liquid-state battery. The solid-state battery is a battery that contains a solid electrolyte, and the existence of liquid is allowed. For example, the solid-state battery may contain a liquid component (lubricant) for increasing the lubricity between solid materials. In the battery 100, the proportion of the solid electrolyte (for example, a sulfide solid electrolyte) in the whole electrolyte may be more than 50 mass %. Alternatively, the battery 100 may contain only the solid electrolyte (for example, a sulfide solid electrolyte) as the electrolyte (that is, the battery 100 does not need to contain a liquid electrolyte). The battery 100 may be an all-solid-state battery that does not substantially contain liquid. The positive electrode active material layer 10 of the battery 100 may contain a solid electrolyte (for example, a sulfide solid electrolyte), together with the composite active material 1 in the present disclosure. The electrolyte layer 20 of the battery 100 may contain a solid electrolyte (for example, a sulfide solid electrolyte) and a binder. The negative electrode active material layer 30 of the battery 100 may contain a solid electrolyte (for example, a sulfide solid electrolyte), together with a negative electrode active material.

Embodiments of the composite active material and others have been described above. In the technology in the present disclosure, various modifications can be made other than the above embodiments, without departing from the spirit of the technology in the present disclosure. The technology in the present disclosure will be described below in more detail, with examples. The technology in the present disclosure is not limited to the following examples.

### 1. Preparation of Composite Active Material

### 1.1 Example 1, Comparative Examples 1 and 2

Composite active materials according to Example 1 and Comparative Example 1 and 2 were produced in the following procedure.

### 1.1.1 Production of Precursor Particle

(1) MnSO₄·5H₂O, NiSO₄·6H₂O, and CoSO₄·7H₂O were weighed at an intended composition ratio (Mn:Ni:Co=4:2:4), and were dissolved in distilled water at a concentration of 1.2 mol/L, so that a first solution was obtained. Further, in another container, Na₂CO₃ was dissolved in distilled water at a concentration of 1.2 mol/L, so that a second solution was obtained.

(2) In a reaction container (which includes a baffle plate), 1000 mL of pure water was put, and 500 mL of the first solution and 500 mL of the second solution each were dropped at a speed of about 4 mL/min.

(3) After the end of the dropping, stirring was performed at room temperature at a stirring speed of 150 rpm for 1 hour, so that a product was obtained.

(4) The product was washed by pure water, solid-liquid separation was performed by a centrifugal separator, and a precipitate was retrieved.

(5) The obtained precipitate was dried at 120° C. overnight, and after the grinding in a mortar, coarse powder was retrieved by airflow classification, so that a precursor particle was obtained.

### 1.1.2 Production of Mixture (Composite Body)

The above precursor particle and Na₂CO₃ were mixed using a mortar, and thereby, the surface of the precursor particle was covered with Na₂CO₃, so that a mixture (composite body) was obtained.

### 1.1.3 Production of P2-Type Na-Containing Oxide Particle

The above mixture (composite body) was put in an alumina crucible, and firing was performed under the air atmosphere, so that a Na-containing oxide having the P2-type structure was obtained. The firing condition was shown in the following (1) to (6).

(1) The alumina crucible containing the above mixture (composite body) is installed in the furnace under the air atmosphere.

(2) The temperature of the interior of the furnace is raised from room temperature (25° C.) to 600° C. for 120 minutes.

(3) The interior of the furnace is kept at 600° C. for 360 minutes, and the preliminary firing is performed.

(4) After the preliminary firing, the temperature of the interior of the furnace is raised to 900° C. for 100 minutes.

(5) The interior of the furnace is kept at 900° C. for 120 minutes, and the real firing is performed.

(6) After the real firing, the temperature of the interior of the furnace is decreased from the real firing temperature to 250° C. Then, the alumina crucible is taken out from the furnace at 250° C., and radiational cooling is performed in the exterior of the furnace under the dry atmosphere, such that the temperature reaches 25° C. in 10 minutes.

The fired product after the radiational cooling was ground under the dry atmosphere using a mortar, so that the Na-containing oxide particle (P2-type particle) having the P2-type structure was obtained. The Na-containing oxide particle was a plate-shaped particle in which the aspect ratio in the cross-section shape was 1.5 or more.

### 1.1.4 Ion Exchange

(1) LiNO₃ and LiCl were weighed at a mole ratio of 50:50, and were mixed with the above P2-type particle at a mole ratio of 10 times the minimal Li amount that is necessary for the ion exchange, so that a mixture was obtained.

(2) The ion exchange was performed at 280° C. under the air atmosphere for 1 hour, using an alumina crucible, so that a product containing the Li-containing oxide was obtained.

(3) Salts remaining in the product were removed by pure water, and solid-liquid separation was performed by vacuum filtration, so that a precipitate was obtained.

(4) The obtained precipitate was dried at 120° C. overnight, so that a Li-containing oxide particle having the O2-type structure was obtained.

### 1.1.5 Oxide Coating

(1) First, 4.52 g of metaphosphoric acid (manufactured by FUJIFILM Wako Pure Chemical Corporation) was dissolved in 191.8 g of ion-exchange water. Next, boric acid (manufactured by NACALAI TESQUE, INC.) was added and dissolved such that the mole ratio (B/P) became 1.0. Furthermore, lithium hydroxide monohydrate (manufactured by FUJIFILM Wako Pure Chemical Corporation) was added such that the mole ratio (Li/(P+B)) became 1.00, and stirring was performed. Thereby, a coat liquid containing the Li source, the P source, and the B source was obtained.

(2) The above Li-containing oxide particle is mixed in the coat liquid, so that a slurry was obtained.

(3) The slurry was dried using a spray-dry device, so that a solid content was obtained. The particle diameter of the solid content could be changed by changing the atomizing air pressure of the spray-dry device.

(4) The solid content was thermally treated at 200° C. under the air atmosphere for 5 hours. Thereby, the whole of the surface of the active material particle was covered with a coat layer. The coat layer contained Li, B, P, and O as constituent elements.

### 1.1.6 Li Doping

(1) In a glove box (Ar atmosphere), 9-fluorenone was mixed and dissolved in tetrahydrofuran (THF), so that a fluorenone solution was obtained.

(2) A Li foil is thrown in the fluorenone solution, and stirring was performed for 2 hours, so that a reduction solution containing the Li ion was obtained.

(3) In the obtained reduction solution, the Li-containing oxide particle after the oxide coating was thrown and immersed, and stirring was performed for 24 hours.

(4) The particle after the stirring was washed by THE, and solid-liquid separation was performed by vacuum filtration. The obtained precipitate was dried at 120° C. overnight, so that a composite active material for evaluation was obtained.

### 1.2 Example 2

Fine powder was retrieved by airflow classification, so that a thin precursor particle was obtained. Using the obtained precursor particle, the production of the mixture (composite body), the production of the P2-type Na-containing oxide particle, the ion exchange, the oxide coating, and the Li doping were performed under the same conditions as those in Example 1, so that a composite active material for evaluation was obtained.

### 2. Chemical Composition of Active Material Particle and Confirmation of Crystal Structure

For each of Examples 1 and 2 and Comparative Examples 1 and 2, the chemical composition of the active material particle was confirmed, and as a result, was shown as Li_{1.0}Mn_{0.4}Ni_{0.2}Co_{0.4}O₂. Further, a crystal phase contained in the active material particle was confirmed by XRD, and as a result, the active material particle had the O2-type structure. Further, the active material particle was a plate-shaped particle in which the aspect ratio in the cross-section shape was 1.5 or more. The cross-section observation method has been described in the embodiment in the present specification.

### 3. Measurement of Particle Diameter and External Appearance Observation

For each of Examples 1 and 2 and Comparative Example 1 and 2, the particle diameter (D10, D50, D90) of the active material particle before the oxide coating and the particle diameter (D10, D50, D90) of the composite active material were measured. Further, each composite active material was sprinkled on a carbon tape, and was put on a jig.

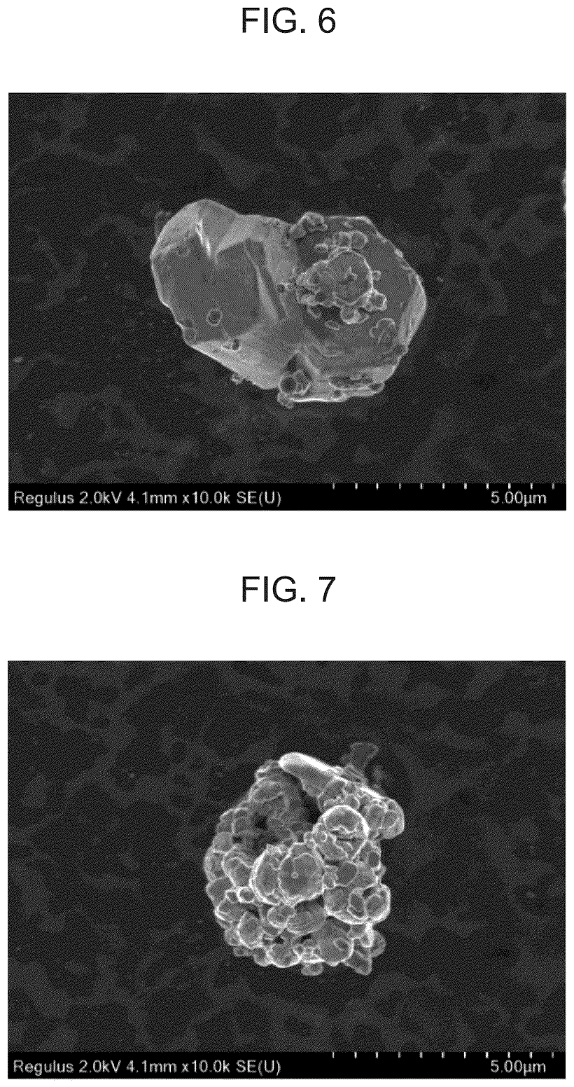

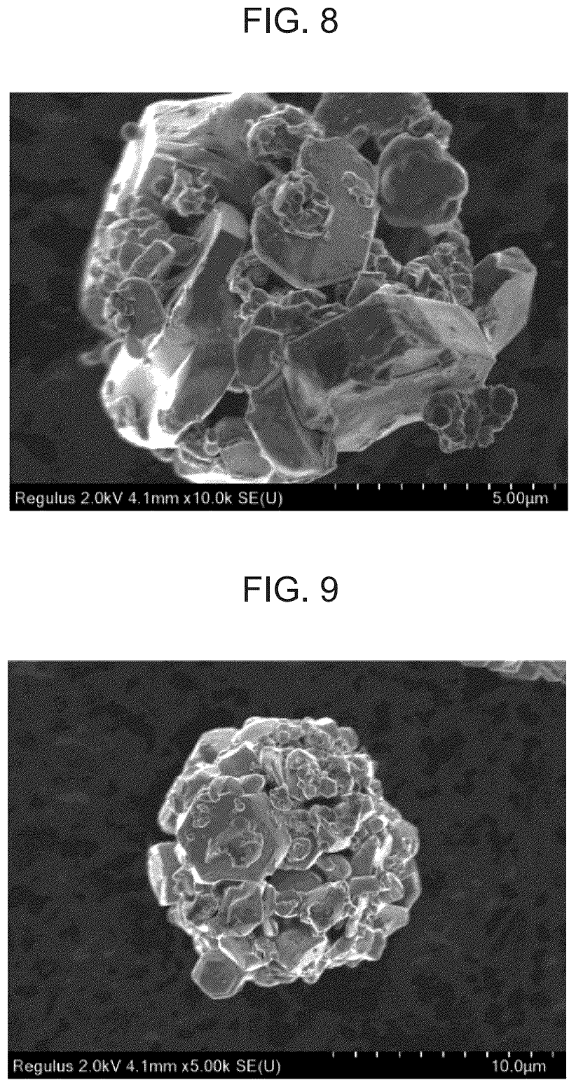

Then, the jig was mounted on a FE-SEM, and the external appearance of the composite active material was confirmed. FIGS. 6 to 9 show SEM images obtained by the observation of the external appearances of the respective composite active materials in Examples 1 and 2 and Comparative Examples 1 and 2.

### 4. Production of Cell for Evaluation

(1) The above-described composite active material for evaluation, the sulfide solid electrolyte, vapor-grown carbon fiber (VGCF), and a PVdF binder were weighed such that the mass ratio was active material:sulfide solid electrolyte:VGCF:binder=81:16:1:2. The respective weighed components were dispersed and mixed in DIBK, so that a positive electrode slurry was obtained. The positive electrode slurry was applied on an Al foil as a positive electrode current collecting foil, by a blade method, and was dried on a hot plate, so that a positive electrode active material layer was formed on the Al foil.

(2) Lithium titanate (LTO) as the negative electrode active material, the sulfide solid electrolyte, VGCF, and the PVdF binder were weighed such that negative electrode active material: sulfide slid electrolyte:VGCF:binder=72:23:3:2 was satisfied, and were dispersed and mixed in butyl butyrate, so that a negative electrode slurry was obtained. The negative electrode slurry was applied on a Ni foil as a negative electrode current collecting foil, by the blade method, and was dried on the hot plate, so that a negative electrode active material layer was formed on the Ni foil.

(3) The sulfide solid electrolyte, the PVdF binder, and butyl butyrate were stirred by an ultrasonic dispersion device, so that a solid electrolyte slurry was obtained. The mass ratio of the sulfide solid electrolyte and the PVdF binder was 99.4:0.6. The solid electrolyte slurry was applied on an Al foil as a base material, by the blade method, and was dried on the hot plate at 100° C. for 30 minutes, so that a peelable solid electrolyte layer was obtained.

(4) The above positive electrode active material layer and the above solid electrolyte layer were laminated, and were pressed at a press pressure of 50 kN/cm and a temperature of 160° C., by a roll press machine. Thereafter, the Al foil was peeled from the solid electrolyte layer, and punching was performed such that the size became 1 cm². Thereby, a positive electrode laminate body was obtained.

(5) The above negative electrode active material layer and the above solid electrolyte layer were laminated, and were pressed at a press pressure of 50 kN/cm and a temperature of 160° C., by the roll press machine. Thereafter, the Al foil was peeled from the solid electrolyte layer, so that a negative electrode laminate body was obtained. Furthermore, an additional solid electrolyte layer was laminated on the solid electrolyte side of the above negative electrode laminate body, and was tentatively pressed at a press pressure of 100 MPa and a temperature of 25° C., by a planar single-axis press machine. Thereafter, the Al foil was peeled from the solid electrolyte layer, and punching was performed such that the size became 1.08 cm². Thereby, a negative electrode laminate body including the additional solid electrolyte layer was obtained.

(6) The above positive electrode laminate body and the above negative electrode laminate body including the additional solid electrolyte layer were laminated such that material coupling surfaces faced each other, and were pressed at a press pressure of 200 MPa and a temperature of 120° C., by the planar single-axis press machine, so that a battery laminate body was obtained.

(7) The above battery laminate body was sandwiched between two confining plates, and the two confining plates were fastened at a confining pressure of 5 MPa, by a fastener, such that the distance between the two confining plates was fixed. Thereby, a cell for evaluation was obtained.

### 5. Measurement of Capacity

In a thermostatic chamber kept at 25° C., the cell for evaluation was charged and discharged at 0.1 C (1C=220 mA/g) in a voltage range of 0.45 V to 3.25 V, and an initial discharge capacity was measured.

### 6. Measurement of Resistance

In the thermostatic chamber kept at 25° C., the cell for evaluation was charged at 0.1 C (1C=220 mA/g) in a voltage range of 0.45 V to 3.25 V, and thereafter, was discharged until the SOC became 50%. After the SOC reached 50%, discharge was performed at 3.0 C for 10 seconds, and a 0.1 s resistance value and 10s resistance value at a SOC of 50% were measured.

### 7. Evaluation Result

Table 1 shows the particle diameter (D10, D50, D90) of the active material particle before the oxide coating, the particle diameter (D10, D50, D90) of the composite active material after the oxide coating and the Li doping, the initial discharge capacity of the cell for evaluation, and the 0.1 s resistance value and 10 s resistance value at a SOC of 50%, for each of Examples 1 and 2 and Comparative Examples 1 and 2.

TABLE 1

| | Active Material | | | Composite Active | | | | | Initial |
|---|---|---|---|---|---|---|---|---|---|
| | Particle | | | Material | | | 0.1 s | 10 s | Discharge |
| | D10 | D50 | D90 | D10 | D50 | D90 | Resistance | Resistance | Capacity |
| | μm | μm | μm | μm | μm | μm | Ω | Ω | mAh/g |
| Example 1 | 1.3 | 3.1 | 5.6 | 3.18 | 5.42 | 8.64 | 19 | 31 | 244 |
| Example 2 | 0.61 | 1.58 | 4.04 | 2.90 | 5.01 | 7.97 | 16 | 28 | 236 |
| Comparative | 1.3 | 3.1 | 5.6 | 3.27 | 5.90 | 9.84 | 37 | 62 | 230 |
| Example 1 | | | | | | | | | |
| Comparative | 1.3 | 3.1 | 5.6 | 3.42 | 6.67 | 10.90 | 46 | 66 | 229 |
| Example 2 | | | | | | | | | |

The results shown in Table 1 reveal the followings. When the particle diameter (D50) of the composite active material is less than 5.90 μm (Examples 1 and 2), the resistance is lower and the capacity is higher, compared to when the particle diameter (D50) of the composition active material is 5.90 μm or more (Comparative Examples 1 and 2). In the above examples, the active material for evaluation that has the predetermined chemical composition has been exemplified, but the chemical composition of the active material is not limited to this. It is thought that the same effect is exerted when the active material contains at least one transition metal element of Mn, Ni, and Co as a constituent element.

What is claimed is:

1. A composite active material including an active material particle and a coat layer, wherein:
the active material particle has an O2-type structure;
the active material particle contains, as constituent elements, Li,
at least one transition metal element of Mn, Ni, and Co, and O;
the coat layer covers at least a part of a surface of the active material particle;
the coat layer is a layer of an oxide that contains Li as a constituent element; and
a particle diameter (D50) of the composite active material is less than 5.90 μm.

2. The composite active material according to claim 1, wherein the coat layer contains Li, B, P, and O, as constituent elements.

3. The composite active material according to claim 1, wherein the particle diameter (D50) of the composite active material is 5.42 μm or less.

4. The composite active material according to claim 1, wherein the active material particle contains Li, Mn, Ni, Co, and O, as constituent elements.

5. A battery including a positive electrode active material layer, an electrolyte layer, and a negative electrode active material layer, wherein
the positive electrode active material layer contains the composite active material according to claim 1.
